(19) United States
(12) Patent Application Publication
(10) Pub. No.: US 2024/0188546 A1
(43) Pub. Date: Jun. 13, 2024

(54) HIVE STRUCTURE WITH FEATURE FACILITATING PROPOLIS ACCUMULATION

(71) Applicant: JEFF JOHNSON, SIOUX FALLS, SD (US)

(72) Inventor: JEFF JOHNSON, SIOUX FALLS, SD (US)

(21) Appl. No.: 18/064,365

(22) Filed: Dec. 12, 2022

(51) Int. Cl. A01K 47/02

(52) U.S. Cl. CPC A01K 47/02

(57) ABSTRACT

A hive supporting apparatus for supporting elements of a hive may include a housing assembly having an interior space for accommodating at least one comb and having a housing segment with a perimeter wall having an interior surface about a portion of the interior space. The perimeter wall may include a plurality of wall portions each having a wall portion surface forming a portion of the interior surface and having a primary plane. A section of the interior surface of the perimeter wall may have a propolis-encouraging feature located on at least one of the wall portions of the perimeter wall. The propolis-supporting surface section may have a contour which extends out of the primary plane of the wall portion surface of the respective wall portion.

Index of Elements for HIVE STRUCTURE WITH
FEATURE FACILITATING PROPOLIS ACCUMULATION

1.
2.
3.
4.
5.
6.
7.
8.
9.
10. Hive supporting apparatus
11.
12. Housing assembly
13.
14. Interior space of assembly 12
15.
16. Top of assembly 12
17. Bottom of assembly 12
18. Top opening of assembly 12
19.
20. (first) Housing segment of assembly 12
21.
22. (second) Housing segment-assembly 12
23.
24. Upper opening of segment 20
25.
26. Lower opening of segment 20
27.
28.
29.
30. Perimeter wall of segment 20
31.
32. Interior surface of wall 30
33.
34. (first) Wall portion of wall 30
35.
36. (second) Wall portion of wall 30
37.
38. (third) Wall portion of wall 30
39.
40. (fourth) Wall portion of wall 30
41.
42. Wall portion surface of segment 34
43.
44. Primary plane of surface 42
45.
46.
47.
48.
49.
50. (contoured) Section of surface 50
51.
52. Propolis-encouraging feature
53.
54. Contour of feature 52
55.
56.
57.
58.
59.
60. Perimeter frame-apparatus 10
61.
62. (first) Support tab of frame 60
63.
64. (second) Support tab of frame 60
65.
66. Opening of frame 60
67.
68. Comb supportive member of frame 60
69.
70.
71.
72.
73.
74.
75.
76.
77.
78.
79.
80.

### BACKGROUND

### Field

The present disclosure relates to beehive structures and more particularly pertains to a new hive structure with a feature to facilitate propolis accumulation to provide the benefits of propolis to a hive in an artificial hive structure.

### SUMMARY

In one aspect, the present disclosure relates to a hive supporting apparatus for supporting elements of a hive. The apparatus may comprise a housing assembly having an interior space for accommodating at least one comb. The housing assembly may include at least one housing segment configured to define a portion of the interior space of the housing assembly, and the housing segment may comprise a perimeter wall having an interior surface for extending about a portion of the interior space circumscribed by the perimeter wall. The perimeter wall may include a plurality of wall portions with each of the wall portions having a wall portion surface forming a portion of the interior surface of the perimeter wall. Each wall portion surface may have a primary plane. A section of the interior surface of the perimeter wall may have a propolis-encouraging feature, and the propolis-encouraging feature may be located on at least one of the wall portions of the perimeter wall. The propolis-supporting surface section may have a contour, and the contour may extend out of the primary plane of the wall portion surface of the respective wall portion.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic side view of elements of a new hive structure with a feature to facilitate propolis accumulation according to the present disclosure, including a hive supporting apparatus with a housing assembly comprising a plurality of stacked housing segments.

FIG. 2 is a schematic perspective view of an illustrative housing segment of the housing assembly, according to an illustrative embodiment.

FIG. 3 is a schematic top view of the illustrative housing segment of the housing assembly, according to an illustrative embodiment.

FIG. 4 is a schematic side view of a supportive perimeter frame of the hive supporting apparatus, according to an illustrative embodiment.

FIG. 5 is a schematic side view of a section of the interior surface of the perimeter wall of a housing segment with an example of illustrative contours of a propolis-encouraging feature, according to an illustrative embodiment.

FIG. 6 is a schematic side view of a section of the interior surface of the perimeter wall of a housing segment with a further example of illustrative contours of a propolis-encouraging feature, according to an illustrative embodiment.

FIG. 7 is a schematic cross-sectional view of a broken away section of a wall portion of the perimeter wall showing illustrative contours in cross-section, according to an illustrative embodiment.

### DETAILED DESCRIPTION

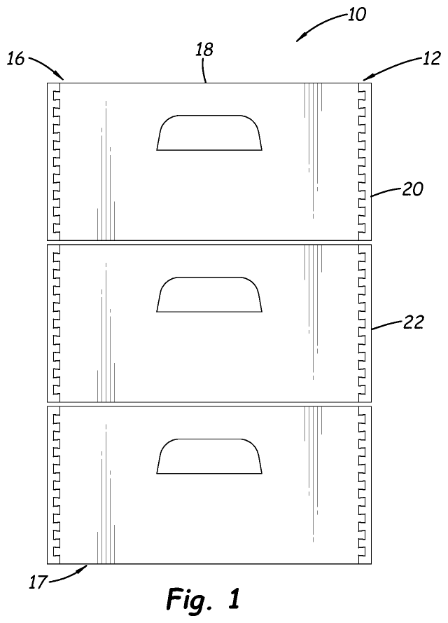

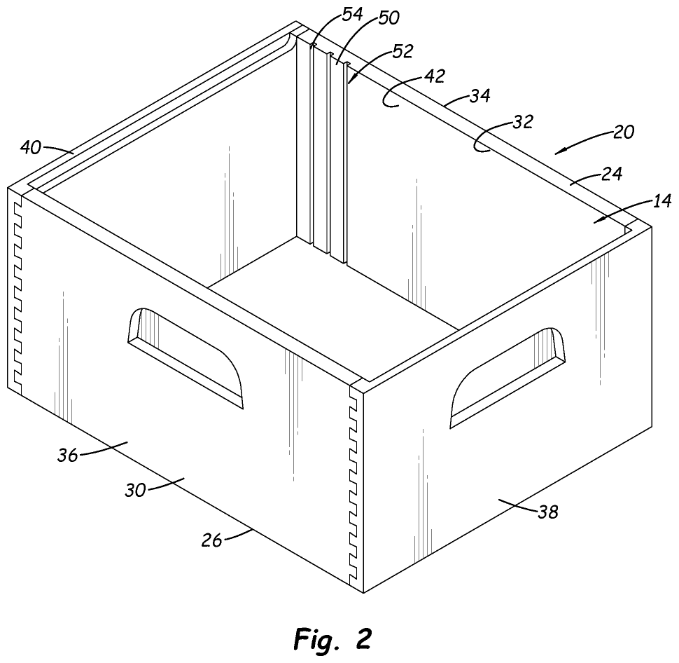

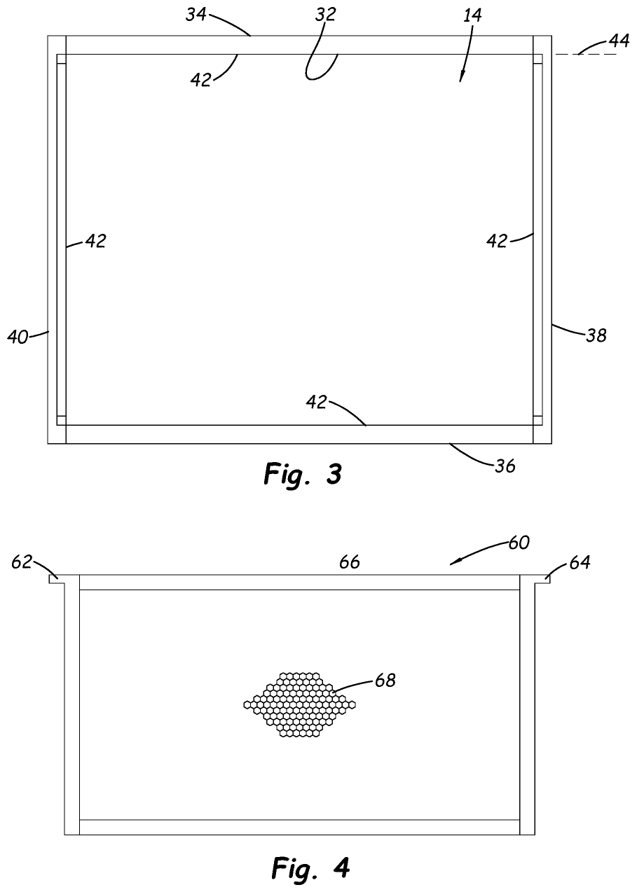

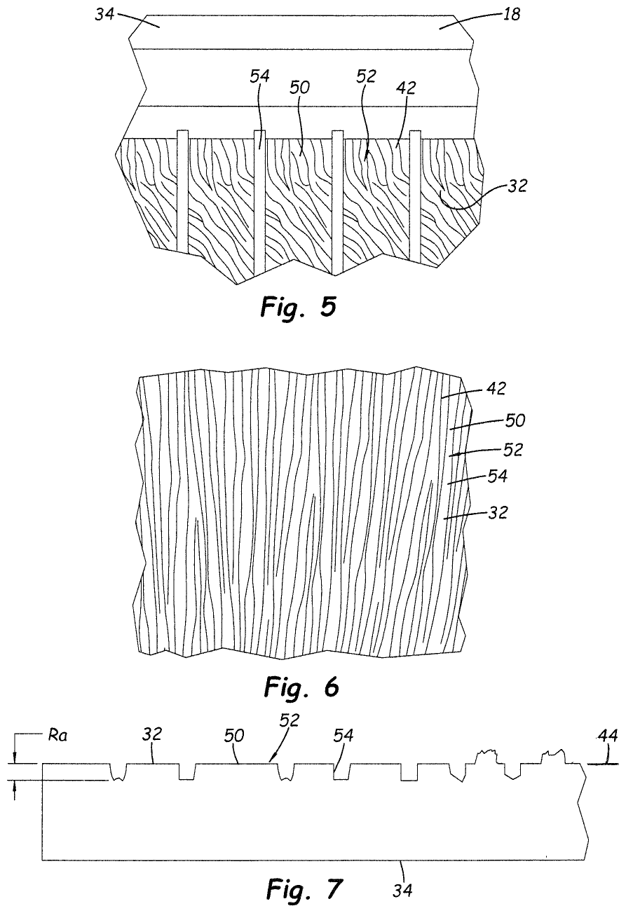

With reference now to the drawings, and in particular to FIGS. 1 through 7 thereof, a new hive structure with at least one feature to facilitate propolis accumulation that embodies the principles and concepts of the disclosed subject matter will be described.

The applicants have recognized that conventional hive boxes are typically optimized for easier cleaning of the boxes, including the inward facing surfaces surrounding the interior of the hive structure that are most likely to come in contact with the bees and the substances brought into the interior of the hive by the bees. To this purpose, the surfaces of the boxes are typically planed and/or sanded smooth to facilitate cleaning of the surfaces as well to simplify the fabrication of the elements forming the hive boxes, usually wood boards. In some cases, the board surfaces may be coated with paint to seal the boards as well as ease the cleaning of the surfaces.

The applicants have also recognized that the smooth finished character of the interior surfaces of the hive box tends to discourage, or at least does not encourage, the deposit of propolis on the interior surfaces of the hive box by the resident bees. Propolis is a resinous substance that the bees of the hive produce by mixing saliva and beeswax with exudate gathered from available plant sources. The function of propolis is believed to be tied primarily to forming the structure of the hive (such as for sealing small cracks in the hive enclosure) in natural locations (e.g., a void in a tree trunk), a function which is generally thought to have less usefulness in man-made or manufactured hive structures which do not have small cracks needing to be closed off. In fact, the accumulation of propolis on the interior surfaces of the manufactured hive boxes has been considered to be a bit of a nuisance, and something to be cleaned or cleared from the hive box.

The applicants have also recognized that research has indicated that propolis may have benefits to the health of the hive and the resident bees, with respect to, for example, warding off parasites and/or disease. Thus, the applicants have recognized that, rather than only being a nuisance in manufactured hive structures, the presence of the propolis may be something to encourage and facilitate the accumulation of in a manufactured hive structure.

The applicants have therefore developed hive structures, and more particularly hive boxes, which are believed to encourage and facilitate the accumulation of propolis in the manufactured hive structure by, for example, providing surfaces forming the interior of the hive structure that are contoured in a manner that deviates from a flat and smooth shape to shapes that provide purchase for propolis deposits on the surface.

In some aspects, the disclosure relates to a hive supporting apparatus 10 which is generally configured to support elements of a hive of bees, in particular honeybees which construct a comb, or honeycomb, to contain honey as well as other elements to support the continuing operation by the bees of the hive.

The hive supporting apparatus 10 includes a housing assembly 12 which has an interior space 14 for accommodating at least one honeycomb. In embodiments of the housing assembly 12, the interior space 14 may be expandable, such as by the housing assembly being modular in construction to permit an extension of the assembly 12 to increase a distance between the top 16 and the bottom 17 of the assembly 12. Additionally, the modularity of the assembly 12 may permit the interior space 14 of the housing assembly to be decreased housing assembly may include a top opening 18 located at the top 16 of the assembly.

The housing assembly 12 may include at least one housing segment 20 which is configured to define a portion of the interior space of the assembly 12. Typically, but not critically, a plurality of the housing segments 20, 22 may be removably stackable upon each other to increase the interior space of the assembly 12. The housing segments 20, 22 may be configured to align with each other when stacked such that the portions of the interior space defined by each of the segments 20, 22 are in communication with each other, and typically vertically aligned with each other. Each of the housing segments 20, 22 has an upper opening 24 and a lower opening 26, and when stacked, the lower opening of an upper housing segment is in communication with the upper opening of a lower housing segment in the stack of segments forming the housing assembly.

In greater detail, each of the housing segments may comprise a perimeter wall 30 with an interior surface 32 which extends about the portion of the interior space 14 circumscribed by the perimeter wall. The perimeter wall 30 may be rectangular in shape in a horizontal cross-section, and may include a plurality of wall portions 34, 36, 38, 40 with each of the wall portions forming one of the sides of the rectangular cross-section. Each of the wall portions 34, 36, 38, 40 has a wall portion surface 42 forming a portion of the interior surface 32 of the perimeter wall. A wall portion surface 42 may define a primary plane 44, and a majority of the wall portion surface may lie in the primary plane. The wall portion surface 42 of adjacent wall portions may be oriented substantially perpendicular to each other.

A section 50 of the interior surface 32 of the perimeter wall has a propolis-encouraging feature 52. The propolis-encouraging feature 52 may be located on at least one of the wall portions 34, 36, 38, 40 of the perimeter wall, and may be located on two or more or all of the wall portions. The propolis-encouraging feature of the section 50 may comprise a propolis-supporting surface. The propolis-supporting surface section 50 may have at least one contour 54. The contour 54 may extend out of the primary plane 44 of the wall portion surface 42 of the respective wall portion. Illustratively, the contour 54 may extend into the wall portion with respect to the primary plane and/or the contour may extend out from the wall portion with respect to the primary plane.

In embodiments, the propolis-supporting surface section 50 may occupy at least approximately 25% of the area of the interior surface 32 of the perimeter wall of a housing segment. In embodiments, the propolis-supporting surface section 50 may occupy less than approximately 75% of the area of the interior surface of the perimeter wall. In embodiments, the propolis-supporting surface section 50 may occupy substantially an entirety of the area of the interior surface of the perimeter wall. In embodiments, the propolis-supporting surface section 50 may occupy between approximately 25% and approximately 75% of the area of the interior surface of the perimeter wall. In some embodiments, the propolis-supporting surface section 50 may occupy less than approximately 25% of the area of the interior surface of the perimeter wall. In other terms, the propolis-supporting surface section 50 may be located on the wall portion surface 42 of one of the wall portions of the housing segment, or optionally two of the wall portions of the housing segment, or optionally three or four of the wall portions of the housing segment.

The contour or contours 54 may be formed on the section 50 of the interior surface in a variety of manners with various degrees of suitability. For example, the contour 54 may be formed on the section 50 of the interior surface 32 by removing material from the interior surface of the wall portion, such as by removing wood material from a board forming the wall portion. Alternatively, or additionally, the contour or contours 54 may be formed on the section 50 of the interior surface 32 by pressing the contours into the interior surface of the wall portion, such as by partially collapsing or crushing areas of the wood material of a board forming the wall portion. Alternatively, or additionally, the contour or contours 54 may be formed by adding material to the interior surface of the wall portion, such as by applying a material to a board forming the wall portion interior surface of the wall portion. In implementations, the formation of the contour or contours 54 may be performed prior to assembly of the wall portions into the fully formed perimeter wall of the housing segment.

As an example of material removal to form the contour or contours, the section 50 of the interior surface 32 may be cut or routed to remove material from the surface of the element (e.g., board) forming the wall portion. As a further example, the contour or contours 54 may be formed by abrading the wall portion surface of the interior surface to remove relatively softer wood material and permit relatively harder wood material to remain. As another example, the contour or contours 54 may be formed by impressing (or pressing contact) of a tool on the wall portion surface 42 of the interior surface. As yet another example, the contour or contours 54 may be formed by embossing the interior surface 32 of the perimeter wall, such as by adding material to the interior surface of the element forming the wall portion.

In some embodiments, the contour or contours 54 may be elongated in shape, and the elongated contours may extend along the section 50 of the interior surface 32 in a primary direction. In some embodiments, the primary direction of the contours 54 may be substantially horizontal and may extend substantially parallel to one (or both) of the upper 24 and lower 26 openings of the housing segment. In some embodiments, the primary direction may be substantially vertical and may extend substantially perpendicular to one (or both) of the upper 24 and lower 26 openings of the housing segment. In still other embodiments, the primary direction may be oblique to the vertical and the horizontal. In embodiments, the contours 54 may extend substantially parallel to each other.

Examples of a feature forming the contour or contours 54 include a slot with substantially parallel side faces and a base face oriented substantially perpendicular to the side faces, a groove with converging side faces, and striations with surfaces that vary in character. The section 50 of the interior surface may include a single one of these features, or may include a plurality of these features which may be spaced from each other with areas of the interior surface which do not have these features. The contours 54 may include one type of these features, or a combination of two or more types of these features.

In some embodiments, the contour 54 of the section of the interior surface may be characterized by a roughness of the interior surface which produces localized deviations of the surface from the primary plane 44. The relative roughness of the section 50 of the interior surface may be further characterized by the profile roughness parameter (Ra). In some embodiments, Ra may be greater than approximately 1/64th inch (e.g., approximately 0.016 inch, or approximately 0.4 mm). In embodiments, Ra may be less than approximately ¼ inch (e.g., approximately 0.25 inch or approximately 6.4 mm), and Ra may be less than approximately ⅛ inch (e.g., approximately 0.125 inch or approximately 3.2 mm).

In some embodiments of the disclosure, the housing assembly 12 of the hive structure may include at least one supportive perimeter frame 60 for supporting a comb of the hive, and the perimeter frame or frames may be removably mounted on the housing segment 20. The supportive perimeter frame 60 may have a pair of support tabs 62, 64 extending from opposite ends of the frame 60, and the support tabs may engage opposite wall portions of the perimeter wall 30, such as by resting in recesses formed in the top edges of the respective wall portions. The supportive perimeter frame or frames 60 typically define an opening 66, and a comb supportive member 68 may extend across the opening 66 to provide a base for combs constructed by the bees resident in the hive. Often, the housing assembly 12 may also comprise a top cover positioned at the top 16 of the housing assembly to cover the top opening 18 of the assembly 12 situated on the uppermost housing segment. The housing assembly 12 may also comprise a bottom wall positioned at the bottom 17 of the housing assembly 12 and may be positioned in a lower opening of the lowermost housing segment.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A hive supporting apparatus for supporting elements of a hive, the apparatus comprising:
a housing assembly having an interior space for accommodating at least one comb, the housing assembly including:
at least one housing segment configured to define a portion of the interior space of the housing assembly, the at least one housing segment comprising a perimeter wall having an interior surface for extending about a portion of the interior space circumscribed by the perimeter wall, the perimeter wall including a plurality of wall portions with each of the wall portions having a wall portion surface forming a portion of the interior surface of the perimeter wall, each wall portion surface having a primary plane;
wherein a section of the interior surface of the perimeter wall has a propolis-encouraging feature, the propolis-encouraging feature being located on at least one of the wall portions of the perimeter wall, the propolis-supporting surface section having a contour, the contour extends out of the primary plane of the wall portion surface of the respective wall portion.

2. The apparatus of claim 1 wherein the contour extends into the wall portion with respect to the primary plane.

3. The apparatus of claim 2 wherein the contour is formed by removing material from the interior surface of the at least one wall portion.

4. The apparatus of claim 2 wherein the contour is formed by pressing contours into the interior surface of the at least one wall portion.

5. The apparatus of claim 1 wherein the contour extends out from the wall portion with respect to the primary plane.

6. The apparatus of claim 5 wherein the contour is formed by adding material to the interior surface of the at least one wall portion.

7. The apparatus of claim 1 wherein the contour comprises at least one slot formed into the interior surface of the at least one wall portion.

8. The apparatus of claim 1 wherein the contour comprises a plurality of slots formed into the interior surface of the at least one wall portion.

9. The apparatus of claim 1 wherein the at least one housing segment has upper and lower openings; and
wherein the contour extends along the portion of the interior surface in a primary direction, the primary direction being substantially horizontal and extending substantially parallel to one of the upper and lower openings of the housing segment.

10. The apparatus of claim 1 wherein the at least one housing segment has upper and lower openings; and
wherein the contour extends along the portion of the interior surface in a primary direction, the primary direction being substantially vertical and extending substantially perpendicular to one of the upper and lower openings.

11. The apparatus of claim 1 wherein the at least one housing segment has upper and lower openings; and
wherein the contour extends along the portion of the interior surface in a primary direction, the primary direction being oblique to one of the upper and lower openings.

12. The apparatus of claim 1 wherein the propolis-encouraging feature includes a plurality of contours extending substantially parallel to each other.

13. The apparatus of claim 1 wherein the hive supporting apparatus additionally comprises at least one supportive perimeter frame removably mounted on the at least one housing segment of the housing assembly, a comb supportive member extending across the opening of the at least one supportive perimeter frame.
